(19) United States
(12) Patent Application Publication
(10) Pub. No.: US 2026/0067874 A1
(43) Pub. Date: Mar. 5, 2026

(54) TIME-DOMAIN REFERENCE SIGNAL PROCESSING IN A WIRELESS COMMUNICATIONS SYSTEM

(71) Applicant: Lenovo (United States) Inc., Morrisville, NC (US)

(72) Inventors: Razvan-Andrei STOICA, Essen (DE); Seyedomid TAGHIZADEH MOTLAGH, Oberursel (DE); Ali Ramadan ALI, Kraiburg am Inn (DE); Karthikeyan GANESAN, Nauheim (DE)

(21) Appl. No.: 19/382,119

(22) Filed: Nov. 6, 2025

(51) Int. Cl. H04W 72/0446; H04L 25/02; H04L 27/26

(52) U.S. Cl. CPC H04W 72/0446; H04L 25/0202; H04L 27/261; H04L 27/265

(57) ABSTRACT

Various aspects of the present disclosure relate to utilizing time-domain multiplexing of both information and reference/sensing signals between transmission nodes and receiving nodes and over available physical resources. In some examples, the present disclosure describes a scalable transform-based multiplexing precoder for joint communications and sensing signals.

### TECHNICAL FIELD

The present disclosure relates to wireless communications, and more specifically to reference signal processing, such as time-domain reference signal processing.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system, via the various communication devices, can perform radio sensing to improve network performance and/or serve various use cases or associated services. Radio sensing operates to obtain environment and/or channel information by using radio-frequency (RF) signaling to detect objects or areas within an environment, such as a physical location or environment that includes a UE or other user devices. For example, a radio sensing mechanism, scheme, or technique can include: transmission of a sensing excitation signal (e.g., a sensing reference signal (RS)) from a sensing Tx node (e.g., a network entity or UE), reception of reflections/echoes of the transmitted sensing excitation signal from the environment by a sensing Rx node (e.g., a network entity or UE), and/or processing of the received reflections to infer information of the environment (e.g., a channel estimate), from the environment (e.g., mobility metrics such as speed or Doppler shift), or objects within the environment.

### SUMMARY

As used herein, including the claims, an article “a” before an element is unrestricted and understood to refer to “at least one” of those elements or “one or more” of those elements. The terms “a,” “at least one,” “one or more,” and “at least one of one or more” may be interchangeable.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.

As used herein, including in the claims, a “set” may include one or more elements.

The present disclosure relates to methods, apparatuses, and systems that facilitate reference signal processing, such as time-domain reference signal processing.

A UE for wireless communication is described. The UE may be configured to, capable of, or operable to perform one or more operations as described herein. For example, the UE may comprise one or more memories and one or more processors coupled with the one or more memories and individually or collectively configured to cause the UE to receive, over a frequency subband, a time-domain multiplexed signal, comprising: a first set of symbols associated with a reference source and a second set of symbols associated with an information source, perform a sensing task based on the time-domain multiplexed signal, and detect the second set of symbols.

A processor for wireless communication is described. The processor may be configured to, capable of, or operable to perform one or more operations as described herein. For example, the processor may comprise one or more memories and one or more controllers coupled with the one or more memories and individually or collectively configured to cause the processor to receive, over a frequency subband, a time-domain multiplexed signal, comprising: a first set of symbols associated with a reference source and a second set of symbols associated with an information source, perform a sensing task based on the time-domain multiplexed signal, and detect the second set of symbols.

A method performed or performable by the UE is described. The method may comprise receiving, over a frequency subband, a time-domain multiplexed signal, comprising: a first set of symbols associated with a reference source and a second set of symbols associated with an information source, performing a sensing task based on the time-domain multiplexed signal, and detecting the second set of symbols.

In some implementations of the UE, processor, and method described herein, the first set of symbols represents a demodulation reference signal (DM-RS) associated with the sensing task.

In some implementations of the UE, processor, and method described herein, the sensing task includes phase tracking, phase noise estimation, or channel estimation.

In some implementations of the UE, processor, and method described herein, the UE, processor, and method may further be configured to, capable of, performed, performable, or operable to receive a configuration that indicates a format and a time-domain allocation of one or more reference signals associated with the reference source or a time-domain allocation of the second set of symbols, apply the configuration to extract a DM-RS from the time-domain multiplexed signal, input the DM-RS into an estimation block to perform the sensing task, and detect the second set of symbols based at least on an output of the sensing task.

In some implementations of the UE, processor, and method described herein, the UE, processor, and method may further be configured to, capable of, performed, performable, or operable to receive, over the frequency subband, the time-domain multiplexed signal, wherein time-domain multiplexed signal comprises a third set of symbols associated with another information source, and discard the third set of symbols associated with the other information source.

In some implementations of the UE, processor, and method described herein, the DM-RS is specifically configured for the UE and wherein the sensing task includes determining a channel estimate for a bandwidth allocated for the second set of symbols associated with the information source.

In some implementations of the UE, processor, and method described herein, the DM-RS is configured for a subband and wherein the sensing task includes determining a channel estimate for the subband.

In some implementations of the UE, processor, and method described herein, the DM-RS is time-domain multiplexed within the time-domain multiplexed signal with respect to one or more sets of symbols.

In some implementations of the UE, processor, and method described herein, the DM-RS is front-loaded with respect to the one or more sets of symbols, back-loaded with respect to the one or more sets of symbols, or interleaved with the one or more sets of symbols.

A network entity for wireless communication is described. The network entity may be configured to, capable of, or operable to perform one or more operations as described herein. For example, the network entity may comprise one or more memories and one or more processors coupled with the one or more memories and individually or collectively configured to cause the network entity to apply a time-domain precoder to multiplex a signal, comprising: a first set of symbols associated with a reference source; and a second set of symbols associated with an information source, map the signal to a frequency subband, modulate the frequency subband to modulate the signal, and transmit the modulated signal.

A method performed or performable by the network entity is described. The method may comprise applying a time-domain precoder to multiplex a signal, comprising: a first set of symbols associated with a reference source; and a second set of symbols associated with an information source, mapping the signal to a frequency subband, modulating the frequency subband to modulate the signal, and transmitting the modulated signal.

In some implementations of the network entity and method described herein, the network entity and method may further be configured to, capable of, performed, performable, or operable to multiplex the signal with a third set of symbols associated with another information source.

In some implementations of the network entity and method described herein, the first set of symbols represents a DM-RS associated with a sensing task.

In some implementations of the network entity and method described herein, the sensing task includes phase tracking, phase noise estimation, or channel estimation.

In some implementations of the network entity and method described herein, the DM-RS is time-domain multiplexed within the signal with respect to one or more sets of symbols.

In some implementations of the network entity and method described herein, the DM-RS is front-loaded with respect to the one or more sets of symbols, back-loaded with respect to the one or more sets of symbols, or interleaved with the one or more sets of symbols.

In some implementations of the network entity and method described herein, the DM-RS comprises a constant-amplitude zero-autocorrelation (CAZAC) sequence or a time-domain impulse function.

In some implementations of the network entity and method described herein, the time-domain precoder comprises a Discrete Fourier Transform (DFT).

In some implementations of the network entity and method described herein, the network entity and method may further be configured to, capable of, performed, performable, or operable to modulate the signal via Orthogonal Frequency Division Multiplexing (OFDM).

### BRIEF DESCRIPTION OF THE DRAWINGS

FIG. 1 illustrates an example of a wireless communications system in accordance with aspects of the present disclosure.

FIG. 2 illustrates an example diagram illustrating between communications devices in accordance with aspects of the present disclosure.

FIG. 3 illustrates an example system realization of a time-domain multiplexing scheme for joint communications and sensing signaling in accordance with aspects of the present disclosure.

FIG. 4 illustrates example components of a precoder in accordance with aspects of the present disclosure.

FIG. 5A illustrates example receiver chain processing of a communications message in accordance with aspects of the present disclosure.

FIG. 5B illustrates time-domain allocations of reference symbols and information symbols in accordance with aspects of the present disclosure.

FIG. 6 illustrates an example channel for a joint communications and sensing signal in accordance with aspects of the present disclosure.

FIG. 7 illustrates example targeting processing of sensing parameters to sensing tasks in accordance with aspects of the present disclosure.

FIG. 8 illustrates an example of a UE in accordance with aspects of the present disclosure.

FIG. 9 illustrates an example of a processor in accordance with aspects of the present disclosure.

FIG. 10 illustrates an example of a network equipment (NE) in accordance with aspects of the present disclosure.

FIG. 11 illustrates a flowchart of a method performed by a UE in accordance with aspects of the present disclosure.

FIG. 12 illustrates a flowchart of a method performed by an NE in accordance with aspects of the present disclosure.

### DETAILED DESCRIPTION

In a wireless communication system, one or multiple NE (e.g., base stations) and UE may support radio sensing with wireless communications (e.g., downlink signaling, uplink signaling, and the like), thereby improving overall performance and enabling various vertical use-cases supported by the wireless communication system. For example, the wireless communications system may implement joint wireless communication and sensing, in which radio sensing functionality is functionally integrated with the wireless communication (e.g., downlink signaling, uplink signaling, and the like) functionality of the wireless communications system.

To effectively utilize joint wireless communication and sensing, the wireless communications system may integrate sensing reference signals with wireless communication (e.g., downlink signaling, uplink signaling, and the like) at a physical (PHY) layer of a protocol stack associated with the NE and/or the UE without degrading the quality of the wireless communication (e.g., downlink signaling, uplink signaling, and the like). To do so, the wireless communications system may utilize multiplexing techniques, such as time-domain multiplexing, to enable use of resources for the PHY layer for both wireless communication and sensing operations.

For example, the wireless communications system may employ time-domain multiplexing of both the wireless communications (e.g., control information, data) and reference (e.g., sensing) signals over available resources to address and/or ensure a low degradation of communication performance while implementing sensing as over-the-top physical signaling. In some examples, the wireless communications system may implement a scalable, transform-based multiplexing precoder to jointly process the wireless communications and sensing. Using the precoder, the wireless communications system may expand upon existing radio transceiver modules with functional additions to support various multiplexing techniques when generating joint communications (e.g., information) and reference (e.g., sensing) signals. For example, the implementation of time-domain multiplexing of communications and reference signals over resources may support the performance of various sensing tasks, such as channel state information (CSI) acquisition and/or object detection using multiplexed reference signals.

Thus, the wireless communications system may efficiently enable joint wireless communications and sensing for NEs and/or UEs in an efficient manner, enabling sensing functionality while preserving/enhancing the spectral and energy efficiency of a network, among other benefits.

Aspects of the present disclosure are described in the context of a wireless communications system.

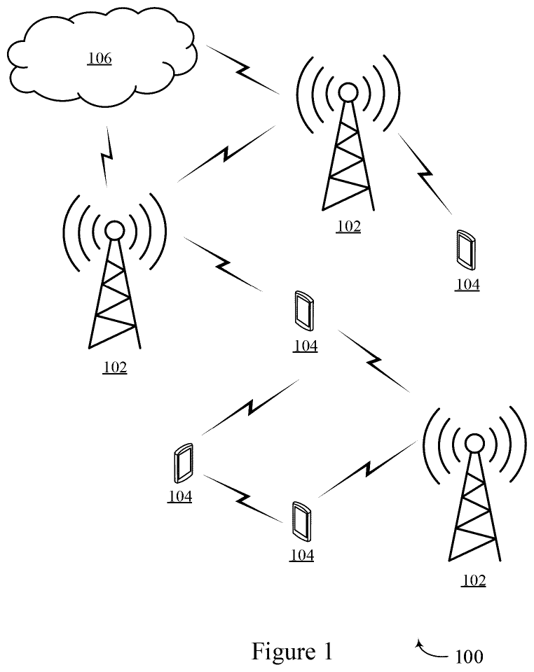

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHz), FR4 (52.6 GHZ-114.25 GHZ), FR4a or FR4-1 (52.6 GHZ-71 GHZ), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, the systems and methods introduce a scalable transform-based multiplexing precoder for communications and sensing signals. The precoder, in some cases, compresses a signaling space to a fixed spectral pool of resources (e.g., resource elements, resource blocks or equivalent spectrum entities) to accommodate time-domain multiplexed and/or non-orthogonal communications and sensing signals (e.g., sensing reference signals, such as DM-RSs), while minimizing intra-signal interference levels. Thus, joint signaling can funnel more information and/or sensing signaling simultaneously over existing orthogonal resources of a communications link within a wireless communications system.

However, issues can arise when utilizing joint communications and sensing signaling, because the two signaling types compete for common physical resources and can deplete the orthogonal resources (e.g., frequency sub-bands/sub-carriers, spatial degrees of freedom, time slots, and so on) of a shared or common channel. The disclosed precoder and its implementation overcomes such issues and provides a flexible approach to the use of joint signaling while preserving spectral efficiency and/or increasing spectrum functionality of the wireless communications system.

As described herein, communications signals/symbols and information symbols/signals may be used interchangeably. Similarly reference signals/symbols and sensing signals/symbols may be used interchangeably. In some cases, communications signals/symbols and information symbols/signals are outputs of an information source, and reference signals/symbols and sensing signals/symbols are outputs of a reference source (e.g., known to a receiver by via configuration by a RAN node).

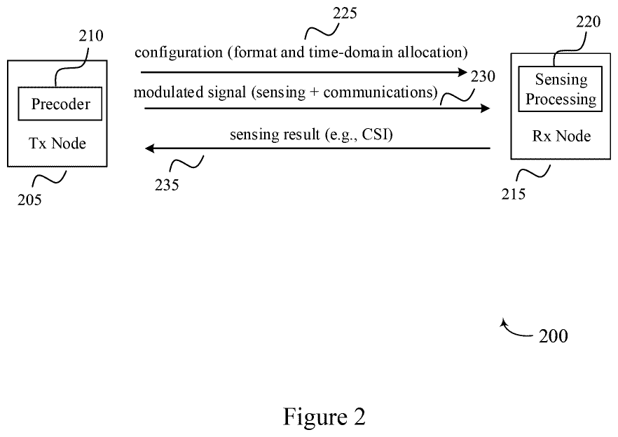

FIG. 2 illustrates an example diagram 200 illustrating signaling between communications devices in accordance with aspects of the present disclosure. A transmitting device 205 (e.g., a Tx node), generates and transmits a modulated signal 230 to a receiving device 215 (e.g., an Rx node). A precoder 210 of the transmitting device 205 precodes the modulated signal, which includes two components, a communications signal (e.g., a set of symbols associated with an information source) and a sensing signal (e.g., a set of symbols associated with a reference source, such as a reference signal). The transmitting device 205 may map the multiplexed signal to a frequency subband (or sub-band), modulate the frequency subband to modulate the signal, and transmit the modulated signal 230 to the receiving device 215. In some cases, the modulated signal 230 (e.g., time-domain multiplexed), covering the frequency subband, may include communications symbols corresponding to one or more other distinct information sources (associated with other Rx nodes).

Various sensing processing components 220 receive the modulated signal 230 and process the modulated signal 230 to extract the signals, detect the communications data, and/or perform various sensing tasks (e.g., detection, estimation, and so on). For example, the sensing processing components 220 may perform a sensing task (e.g., channel estimation) based on the modulated signal 230 and/or detect a set of symbols associated with an information source. Furthermore, the receiver device 215 may transmit a sensing result 235 to the transmitting device 205.

In some cases, the transmitting device 205 may transmit a configuration 225 that indicates a format and a time-domain allocation of one or more reference signals associated with a reference source and/or a time-domain allocation of a set of symbols associated with an information source. The receiving device 215 may apply the configuration 225 to extract a reference signal (e.g., a DM-RS) from the modulated signal 230.

In some cases, the transmitting device 205 may transmit a configuration 225 that indicates a format and a time-domain allocation of one or more reference signals associated with a reference source and/or a time-domain allocation of a set of symbols associated with an information source. The receiving device 215 may apply the configuration 225 to extract a reference signal (e.g., a DM-RS) from the modulated signal 230. Thus, the receiving device 215 (e.g., the UE 104) may be configured to identify a location of common and/or UE-specific reference symbols (e.g., symbols associated with a DM-RS) and corresponding information symbols (e.g., symbols associated with an information source or sources) within the modulated signal 230 (e.g., the time-domain multiplexed signal).

The communications devices, which may be UEs 104 and/or NEs 102, may act as either the Rx node or the Tx node and may implement various multiplexing schemes, such as orthogonal frequency-division multiplexing (OFDM) in either a multi-carrier format (e.g., implemented in 5G NR) or a single carrier format (e.g., DFT-spread-OFDM).

The precoder 210, therefore, may generate the joint signal via non-orthogonal and/or time-domain (e.g., orthogonal) multiplexing. The precoder 210, represented as a linear precoder (W), performs transform-based multiplexing, in the time domain, of an input communications signals (e.g., independent symbols) with an input sensing signal (e.g., a sensing RS or sensing symbols) to orthogonal channel resources, such as OFDM symbols. For example, the modulated signal 230 may include a communication signal (physical downlink control channel (PDCCH), physical downlink shared channel (PDSCH), and so on) multiplexed in orthogonal resources (e.g., time-domain) with a reference signal, such as a DM-RS, a channel state information reference signal (CSI-RS), a tracking reference signal (TRS), a phase tracking reference (PT-RS), and so on.

In some cases, use of a time-domain transform may enable scalability via orthogonal and/or non-orthogonal multiplexing via DFT blocks/modules applied per user or per subband (e.g., a carrier subband that is a contiguous set of resource blocks occupying a subset of resources within a carrier or a bandwidth part (BWP)). For example, the precoder 210 may perform multiplexing for a subband that is equal to and/or larger than the resources allocated to the UE 104. In some cases, the precoder 210 may perform time-domain multiplexing over the subband of multiple different information symbols associated with different UEs 104.

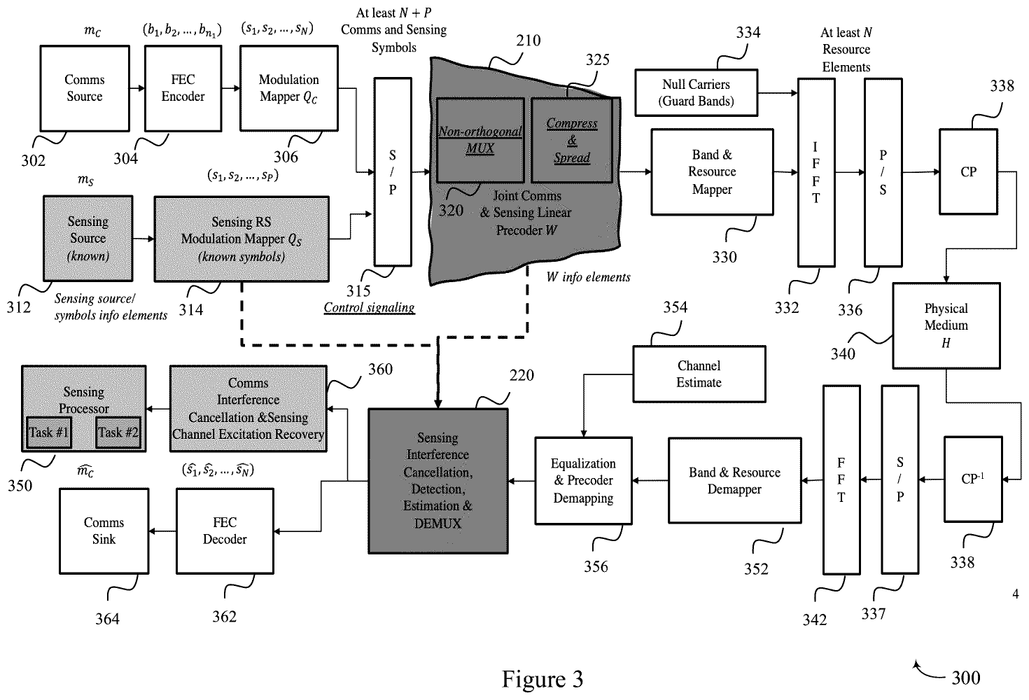

FIG. 3 illustrates an example time-domain multiplexing scheme 300 for joint communications and sensing signaling in accordance with aspects of the present disclosure. The precoder 210 may be an information funnel that minimizes intra-signal space interference (e.g., interference between the communications and sensing signal components) over an underlying OFDM-based waveform. For example, the precoder 210 performs signal space compression, with resulting interference being appropriately managed to reduce signal self-interference effects. In some cases, a codebook may be a set of precoding weights, or vectors, that comprise the precoder 210.

In some cases, the precoder 210 is represented by S (N, N+P, t), such that:
N is the resulting signal space dimensionality (e.g., number of output symbols to be mapped to orthogonal signal space resources corresponding to the precoded joint communications and sensing signal);
N+P is the input signal space dimensionality, such as the aggregate signal space of the communications signals and the sensing signals (e.g., number of communications input symbols, and number of sensing reference symbols, respectively); and
t represent a maximum magnitude of self-interference, considering W column vectors to be normalized to a unit norm.

In some cases, N is a number of subcarriers/resource elements (REs) allocated and used for communications. Generally, N may be the number of medium resources that carry the output of the communications and sensing signals multiplexing. For example, the resources may be frequency sub-carriers, time slots, spatial layers or antenna ports, or combinations thereof. In some cases, N+P is the number of communications symbols and sensing reference signal symbols multiplexed and jointly compressed onto the N orthogonal physical signal space corresponding to the available medium resources available.

In some cases, P and t may be 0, which reduces the precoder W to a linear, orthogonal, orthonormal, and/or orthogonalizable representation. In some cases, P may be a positive integer and t may be positive, which reduces W to a non-orthogonal representation (e.g., a frame in a complex Hilbert space). When P is not 0, the precoder W introduces and designs self-interference in the signal space, utilizing interference cancellation processing at the receiving device 215. When P is 0, the precoder W is invertible by a matched filter transform and no self-interference is introduced in the signal space.

An Rx node, such as the NE 102 and associated processing components 220, may resolve self-interference in the signal space via various mechanisms, including:
forward interference cancellation based on a known sensing reference signal configuration (e.g., known sensing RS symbols assigned to the UE 104, known sensing RS symbols assigned to a sensing task, and so on); and/or
uniform self-interference distribution across the signal space (e.g., knowledge of the precoder W, where W is optimized such that the communications to sensing signal-to-interference ratio (SINR), or reversely, sensing to communications SINR, is fairly controlled and uniformly distributed via the design of the precoder W).

The Rx node, under such conditions and after OFDM demodulation, demapping and equalization, may remove the sensing interference onto the communications signal elements by forward interference cancellation and perform detection of the communications input symbols. The detection mechanisms may undergo least squares filtering, followed by W matched filtering, least squares, linear minimum mean square filtering, other linear-based detection filtering, non-linear detection filtering, or any combinations thereof.

In some examples, when the signal space is not contaminated with self-interference by design of W (e.g., P=0), the receiving device 215 may revert and/or directly process reference signals in the time-domain (e.g., prior to any frequency-domain transformations), reducing the complexity at the receiving device 215. For example, when a reference signal is a DM-RS, the receiving device 215 may use the DM-RS to estimate in the time domain the wireless channel and equalize the channel based on the estimate in the time domain for the current transmission period, or alternatively, for a transmission (e.g., OFDM) symbol. As another example, when a reference signal is a CSI-RS (e.g., beamformed or non-beamformed), the receiving device 215 may use the CSI-RS to acquire the channel estimate and feedback the channel information encoding to the transmitting device 205 using a precoding matrix index representation, singular value decomposition representation, and so on.

As described herein, the Rx node, via a sensing processor 350, may perform various sensing tasks, such as report sensing measurement quantities (e.g., angle, energy/power, Doppler shift of one or more channel paths associated to a sensing target or a defined condition/value range, and so on).

In some cases, the Tx nodes and/or the Rx nodes may transmit or receive one or more transmission/reception/reporting configuration parameters (e.g., describing the sensing RS generation and multiplexing), report configuration of a radio node performing as a sensing Rx, transmit the report of the sensing measurement quantities by a radio node performing as a sensing Rx, and so on.

In some cases, a SensMF (e.g., a sensing management/configuration entity residing in core or in RAN) node may act as an Rx or Tx node.

In some cases, the Tx node and/or Rx nodes may communication via uplink (UL), downlink (DL), or sidelink (SL) physical data and/or control channels defined within a communication network, such as new radio physical broadcast channel (NR PBCH), physical downlink shared channel (PDSCH), physical downlink control channel (PDCCH), physical uplink shared channel (PUSCH), physical uplink control channel (PUCCH), physical sidelink broadcast channel (PSBCH), physical sidelink control channel (PSCCH), physical sidelink shared channel (PSSCH), via a higher layer (e.g., a MAC control element (MAC-CE) or radio resource control (RRC) messages) signaling, where a radio node and/or sensing Rx and/or sensing Tx node is the UE 104;
via a logical interface between the SensMF and the sensing Tx/Rx nodes; and so on.

In some examples, a time-domain application of the precoder W, in its orthogonal realization (e.g., DFT as in DFT-S-OFDM), or in its non-orthogonal realization, may be on the basis of a single UE allocated spectrum (e.g., per UE, user device, or user). The communication reference signals may be DM-RS, CSI-RS, TRS, PT-RS, and so on, as described herein, and they may be generally used for both communications and sensing tasks.

In some examples, the time-domain application of the precoder W, in either its orthogonal realization (e.g., DFT as in DFT-S-OFDM), or in its non-orthogonal realization, may be on the basis of a spectrum/carrier subband, addressing one or more UEs (e.g., per subband). For example, the precoder W multiplexes in the time domain both the reference and communications signals, for one or more UEs. The reference signal may be common to one or more UEs, such as a common DM-RS for all subband DFT-S-OFDM multiplexed UEs. In some examples, each reference signals may be specific to a UE, where each UE has its common DM-RS signal multiplexed in the time domain across an entire subband via the DFT-S-OFDM.

In some examples, the precoder 210 receives combined communications and sensing symbols, such as N+P symbols, at a serial-to-parallel (S/P) synchronization component. A communications source 302 generates communications symbols. For example, the communications source 302 generates information bits that are mapped to constellation points, or alternatively symbols, according to a configuration having a first constellation mapping.

The information symbols may include gray coded constellation points corresponding to the first constellation mapping as an image of the input information bits generated by the source 302. The information bits are sent to a forward error correction (FEC) encoder 304, which performs linear encoding of the input symbols and transmits the linearly encoded symbols to a modulation mapper (Qc) 306. The modulation mapper 306 produces complex-value modulation symbols.

A sensing source 312 generates sensing symbols and transmits symbols (e.g., sensing information elements). The symbols of the sensing source 312 are mapped to constellation points that correspond to a second constellation mapping. The second constellation mapping may be part of the same configuration as the first constellation mapping, or alternatively, formed as a second separate configuration. The second constellation mapping may be the same as the first constellation mapping (e.g., the constellation used for the sensing symbols, s_{S}, is the same as the constellation used for the information communication symbols, s_{C}, such as 16-QAM, or other QAM constellations of different orders). In some cases, the second constellation mapping may be distinct from the first constellation mapping (e.g., the constellation used for the sensing symbols, s_{S}, is for example a 4-QAM/4-PSK constellation and the constellation used for the communications symbols, s_{C}, is for example a 16-QAM constellation).

The sensing symbols may be sent to a sensing RS modulation mapper 306, which generates complex-value modulation symbols of the sensing symbols. The precoder 210 receives the combined symbols (e.g., N+P symbols).

In some examples, the precoder 210 jointly precodes and/or time-domain multiplexes the communications symbols, s_{C}, and the sensing symbols, s_{S}. For example, the precoder 210, via a non-orthogonal multiplexer 320, multiplexes the combined symbols via linear transform-based precoding. As a result, a total of at least N+P communications symbols, s_{C} and sensing/reference symbols, s_{P}, (or sensing RS, sensing pilots, and so on) are multiplexed and compressed together (e.g., via a compression and spread component 325) to N parallel output frequency symbols x. The N+P inputs to the multiplexing linear precoder W, corresponding to s_{C} communication symbols and s_{S} sensing symbols may comprise:
in a sequence, the s_{C} communication symbols followed by the s_{P} reference/sensing symbols;
in block sequences, the s_{C} communications symbols blocked interleaved with the s_{P} sensing symbols, where the size of the blocks, b_{C} and b_{S}, is determined by configuration;
by permutation, where a permutation of the s_{C} communications symbols is multiplexed with a permutation of the s_{P} sensing symbols; and/or various combinations.

In some cases, a signal model obtained after precoding with the multiplexing non-orthogonal linear precoder W is given by x=W·s, where the input vector

$$s = [ \begin{matrix}{s}_{C} \\ {s}_{S}\end{matrix} ]$$

of dimensions N+P corresponds to the non-zero inputs to the linear precoder 210 and comprise both communications and sensing signals, and the output vector x corresponds to the yielded, or alternatively precoded, joint communications and sensing signal.

The vector s may embed, for example, the sensing symbols components s_{P} at positions S, with |S|=P, the communications symbols components s_{C} at the positions C with |C|=N, and respectively S∩C=Ø, and S∪C={1, 2, 3, . . . , N+P}. As such, the sets S and C corresponding to the indices of the sensing and communications symbols are disjoint and complementary with respect to the set of integer non-negative indices up to N+P, such as the input signal space dimensionality.

In some cases, the N precoded communications and sensing symbols x are mapped, via a band and resource mapper 330, to at least N inputs of an OFDM modulator, such as an inverse fast Fourier transform (IFFT) 332. The mapping may be “in sequence,” such that each of the N precoded communications and sensing symbols is mapped to a corresponding, in-order, input to the IFFT 332. Alternatively, the mapping may be “permuted,” such that each of the N precoded communications and sensing symbols is interleaved and mapped to one of the inputs to the OFDM modulator. The OFDM modulation (e.g., via a IFFT linear transform,

$${D}_{N}^{H}$$

may accept at least N inputs. In some cases, null carriers 334, such as silent tones or guard bands, may be additionally added to the N precoded communications and sensing symbols as inputs to the IFFT 332. The silent tones may act, for example, as sub-band guards.

In one example, the resulting baseband OFDM signal is:

$${x}_{B B} = {D}_{N}^{H} \cdot x = {D}_{N}^{H} \cdot W \cdot [ \begin{matrix}{s}_{C} \\ {s}_{S}\end{matrix} ] = {D}_{N}^{H} \cdot W \cdot s .$$

The ODFM symbols, which comprise the precoded N joint communications and sensing symbols may be provided to additional OFDM transmitter processing steps, such as serialization (e.g., via a P/S 336), cyclic prefix insertion 338, corresponding RF antenna/MIMO layer processing (including RF beamforming), up-conversion and transmission over a physical medium 340, such as a wireless physical channel.

In some examples, the linear precoding performed by the transmitting device 205 may be orthogonal. The orthogonal multiplexing of the joint communications and sensing/reference signals (e.g., the modulated signal 230) may be realized by a DFT filter. The DFT filter may be applied to an OFDM modulator, yielding a DFT-S-OFDM waveform. The DFT-S-OFDM waveform may be employed for downlink transmissions (e.g., from the NE 102 (e.g., a gNB) to the UE 104).

In some examples, the linear precoding for non-orthogonal multiplexing of the joint communications and sensing signals may be performed by a truncated discrete Fourier transform (DFT) filter, or a truncated fast Fourier transform (FFT filter), such as the DFT 410. For example, truncation of the DFT for the linear precoder 210 for non-orthogonally multiplexing joint communications and sensing signals of dimensionality N+P may be performed starting from at least an N+P-point DFT as a donor DFT. The donor DFT transform is truncated by removing at least P rows to warrant a linear transform that accepts at least N+P non-zero inputs (e.g., the communications and sensing signals) and outputs at least N outputs (e.g., the precoded joint communications and sensing signal).

Thus, the linear transform W may be sampled out of the N+P-point DFT by truncating the latter by P rows and renormalizing the column vectors norm to unit norm by a factor

$$\sqrt{\frac{N + P}{N}}$$

to obtain:

$$W = \sqrt{\frac{N + P}{N}} \cdot [ \begin{matrix}{w}_{N + P}^{0} & {w}_{N + P}^{1} & … & {w}_{N + P}^{i} & … & {w}_{N + P}^{N + P - 1} ]\end{matrix}$$

with the column vectors

$${w}_{N + P}^{i} ,$$

0≤i≤N+P comprising each of the N+P column vectors of the N+P-point DFT pruned by P entries corresponding to the P pruned rows. The linear precoder W has properties of a harmonic spherical code,

$$S ( N , N + P , max \vert {w}_{N + P}^{i , H} \cdot {w}_{N + P}^{j} \vert ) ,$$

i≠j, 0≤i, j≤N+P, limited to the maximum threshold

$$max \vert {w}_{N + P}^{i , H} \cdot {w}_{N + P}^{j} \vert ,$$

with seir-interference introduced by multiplexing the communications signals, s_{C}, and sensing signals, s_{S}, into the joint communications and sensing signal, x.

In some cases, the P rows selected to be truncated out of the t N+P rows available are statically, or semi-statically, determined by a configuration based on an optimization algorithm targeting the minimization of the maximum self-interference

$$max \vert {w}_{N + P}^{i , H} \cdot {w}_{N + P}^{j} \vert$$

introduced by W.

In some cases, the P rows selected to be truncated out of the at least N+P rows available are dynamically determined based at least on the channel/medium conditions, the Channel State Information at the Transmitter (CSIT), the Channel State Information at the Receiver (CSIR), CSI, sensing task objectives, and/or various combinations.

In some examples, the precoder 210 may be implemented as a truncated DFT filter and include applying an optimized existent N+P-sized FFT operation (e.g., as implemented in hardware/software accelerators based on discrete or embedded processing units, cores, auxiliary dedicated Field Programmable Gate Arrays processing units, and/or various combinations). An outcome of N-point non-zero FFT components may be selected out of the N+P-point FFT, where the N-point FFT outcome corresponds to selected N harmonics or rows/components of the FFT transform corresponding to W. The discarded P-size FFT components include the discarded rows/harmonic components out of the N+P−FFT operation to obtain W.

In some cases, the selected resulting N-point FFT coefficients are weighted for normalization of the precoding column vectors to unit norm. In one example, the yielded N-point coefficients are weighted by

$$\sqrt{\frac{N + P}{N}}$$

to obtain the precoded joint communications and sensing equivalent signal vector x.

In some cases, the DFT block corresponding to the DFT-S-OFDM modulator may be repurposed, as described herein, to generate the equivalent non-orthogonal linear precoding W for joint communications and sensing signal generation x.

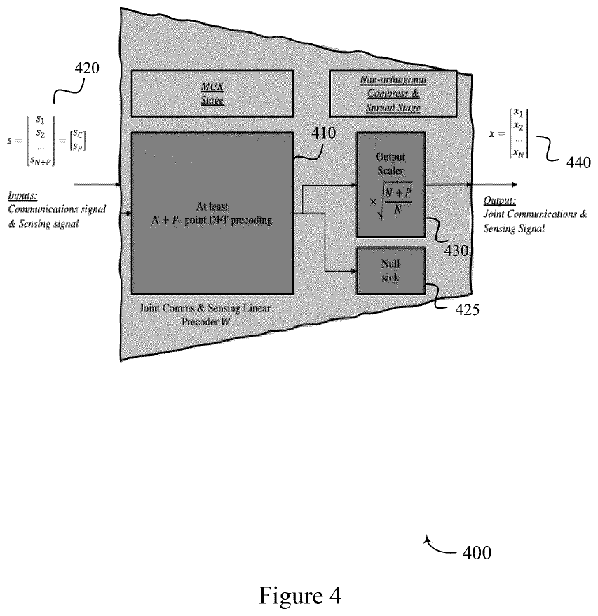

FIG. 4 illustrates example components of a precoder 400 in accordance with aspects of the present disclosure. The precoder 400 reflects the precoder 210 based on and having a DFT block 410. The DFT block 410 receives input 420, such as N+P non-zero inputs, corresponding to N communications symbols (e.g., the communications signal) and to P sensing RS symbols (e.g., the sensing RS and/or the sensing signal). The two signals are mapped as described herein (e.g., by simple appending, block interleaving, or element-wise interleaving/permutations) to generate the input signal s, which is further processed by at least an N+P-point DFT transform to generate at least N+P coefficients. Out of the N+P outputs, P are dropped to a null sink 425, where the positions/indices of the P dropped outputs are determined by higher-layer configuration. The remaining N outputs are scaled by

$$\sqrt{\frac{N + P}{N}}$$

by an output scaler 430 and form the precoded joint communications and sensing equivalent signal vector 440, denoted as x, which is further mapped onto the inputs to a modulator (e.g., the OFDM modulator).

In some cases, a Tx node may be configured by higher layers to dynamically adapt the waveform between DFT-S-OFDM and the non-orthogonal DFT-based linear precoder W, such as the precoder 400, for joint communications and sensing. A legacy DFT-S-OFDM communications mode employed utilized to convey communications signals only over the DFT-S-OFDM. However, the joint communications and sensing variant of non-orthogonal DFT-S-OFDM may be used to transmit a joint communications and sensing signal over the mechanism and corresponding waveform described herein.

Further, the Tx mode may be configured via higher layer control to adapt the power, or alternatively, the ratio P/N of the sensing signal components relative to the communications signal components, for the generation of the joint communications and sensing signal. In some cases, a DFT-S-OFDM legacy waveform may be realized in one transmission occasion by setting the power, or alternatively the number of sensing RS/sensing pilots, P, to zero. In other cases, setting the power, or alternatively the number of sensing RS/sensing pilots, P, to a non-zero value may employ the non-orthogonal DFT-S-OFDM waveform described herein for joint communications and sensing signaling. The adaptive transmitter functional mode and corresponding waveform between legacy DFT-S-OFDM and non-orthogonal DFT-S-OFDM for joint communications and sensing signaling may be configured by radio resource control and/or transmission control information (e.g., in either DL or UL) as an adaptive DFT-S-OFDM waveform.

In some examples, such as when MIMO transmissions are enabled, the linear non-orthogonal precoder W, such as the precoder 400, for the generation of joint communications and sensing signal may be combined with MIMO precoding. In some cases, the combination may include an antenna/layer mapping and MIMO precoding block preceding the W precoding for the generation of a MIMO joint communications and sensing signal.

In other cases, the W precoding block may precede the antenna/layer mapping and MIMO precoding processing. Thus, the precoding by W of a joint communications and sensing signal may be layer-common, whereas, in some cases, the precoding by W of a joint communications and sensing signal may be layer-specific.

In some cases, communications signal components precoded into the joint communications and sensing signal may correspond to a Physical Downlink Shared Channel (PDSCH) transmission. In some cases, the communications signal components precoded into the joint communications and sensing signal may correspond to a Physical Uplink Shared Channel (PUSCH). In some cases, the sensing RS signal components precoded into the joint communications and sensing signal may correspond to a Sensing Channel. The sensing channel may be user-specific or broadcast.

In some cases, the non-orthogonal multiplexed joint communication and sensing signal obtained by precoding with W may form the Physical Shared and Sensing Channel (PXSCH-2), which may comprise an uplink realization and format as a Physical Uplink Shared and Sensing Channel (PUSCH-2) or alternatively as a Physical Downlink Shared and Sensing Channel (PDSCH-2). The PXSCH-2 may have its own namespace, configuration and dedicated control signaling.

In some cases, the non-orthogonal multiplexed joint communications and sensing signal, based on the W precoding over OFDM modulation, forms a new waveform for joint communication and sensing (e.g., a Spread Communications and Sensing OFDM (SCS-OFDM)). The SCS-OFDM waveform may be used for PUSCH-2 type channels, PDSCH-2 type channels, or both.

Returning to FIG. 3, as described herein, the joint signal (e.g., the non-orthogonal multiplexed joint communications and sensing signal x) is modulated and transmitted over the physical medium 340 to a receiver node, such as the NE 102 (or, alternatively, a UE). The modulation may be single-carrier or multi-carrier modulation. In some cases, the modulation and subsequent corresponding demodulation at the receiver node may be OFDM-based (e.g., implemented via the IFFT 332 and the 342 FFT, respectively).

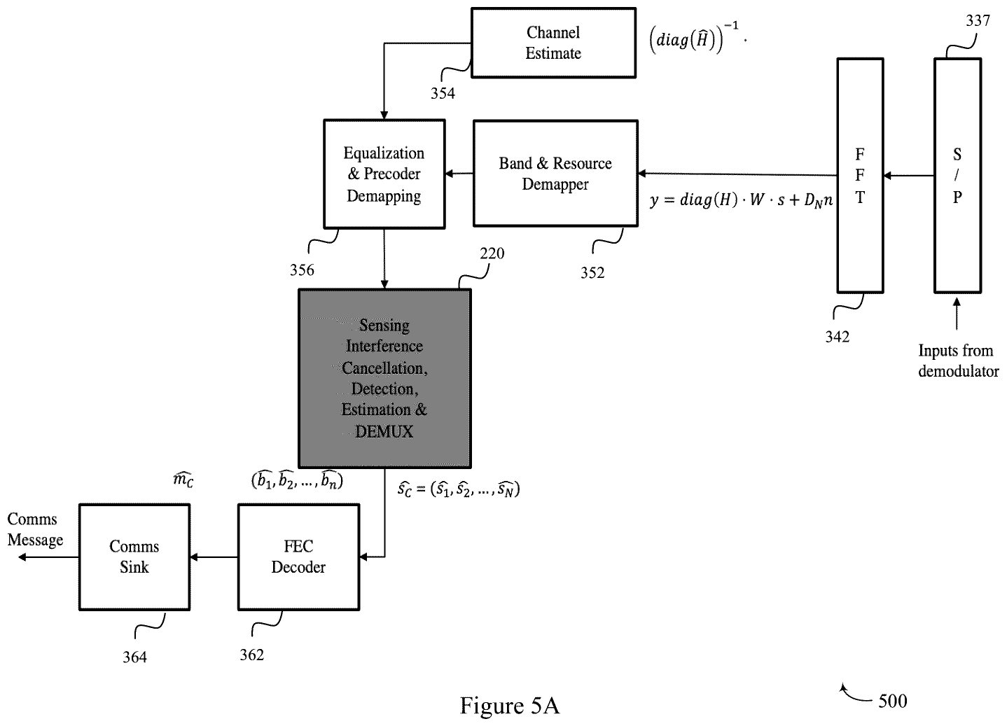

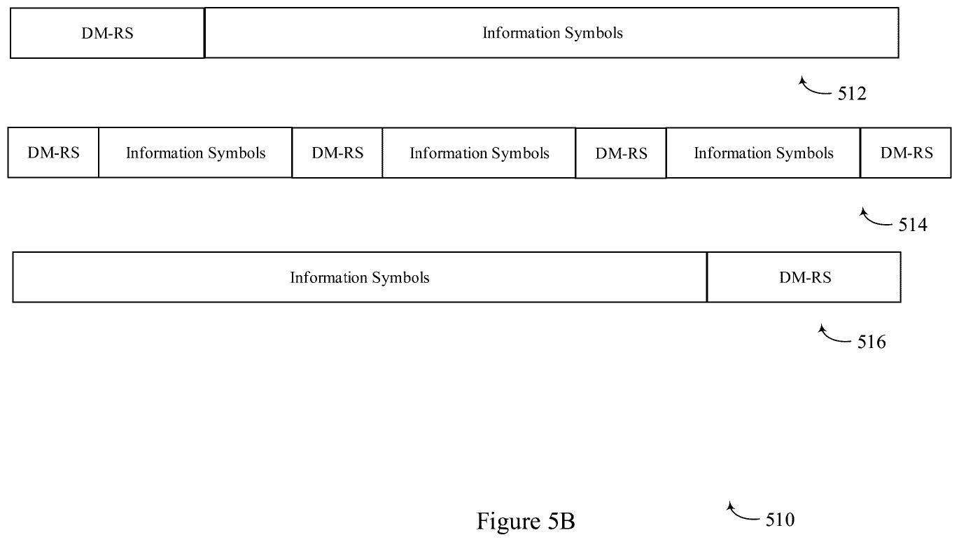

The Rx node receives an analog signal via the physical medium 340 and performs or applies various pre-processing steps, such as down-conversion and/or filtering, and digitizes the received signal for baseband and/or intermediate frequency processing. In some cases, a filtering step may be a precursor of the digital-to-analog conversion, a successor of the digital-to-analog conversion, or a combination thereof. In some cases, the filtering may include passband filtering (e.g., low-pass, bandpass, high-pass filtering), carrier phase and timing synchronization, MIMO combining and processing, or any combination, to maximize the received signal SNR and prepare the signal for baseband processing and symbol detection. FIG. 5A illustrates example receiver chain processing 500 in accordance with aspects of the present disclosure (with reference to the components/steps depicted in FIG. 3).

In some examples, such as those based on OFDM-based transmission-reception, the processing components 220 of the Rx node detect the separate communications signal (e.g., the communications symbols s_{C} from the received signal y of the non-orthogonally multiplexed joint communications and sensing signal x), given that the precoding matrix W and sensing RS signal components s_{S} are known (e.g., based on prior static/semi-static configuration and control signaling, sensing task specific sensing RS, UE-specific sensing RS, and so on). The received signal y may comprise effects of the demodulation, the physical medium, and/or modulation and receiver side baseband noise.

For example, the received signal y post-demodulation may be represented as

$$y = {D}_{N} \cdot ( {D}_{N}^{H} \cdot diag ( H ) \cdot {D}_{N} ) \cdot {D}_{N}^{H} \cdot x + {D}_{N} n$$

where the at least N-point DFT DN corresponds to the FFT transformation of the OFDM demodulator, the at least N-point DFT

$${D}_{N}^{H}$$

corresponds to the IFFT transformation of the OFDM modulator, the diagonal matrix diag(H) corresponds to the physical medium frequency response, the joint matrix

$${D}_{N}^{H} \cdot diag ( H ) \cdot {D}_{N}$$

represents the physical medium circulant discrete time convolution transform of the baseband modulated signal

$${D}_{N}^{H} \cdot x ,$$

and D_{N}n is the outstanding noise component post-demodulation at the Rx node. In some cases, the frequency domain processing of the received signal y may be simplified to y=diag(H)·W·s+D_{N}n, given the expansion of the joint communications and sensing signal x to its precoded representation W·s.

In some examples, physical medium one-tap equalization may be applied (via a band and resource demapper 352, a channel estimate 354, and equalization and precoder demapping 356) to generate equivalent representation:

$${( diag ( H ) )}^{- 1} \cdot y = W \cdot s + {( diag ( H ) )}^{- 1} \cdot {D}_{N} \cdot n$$

for the detection of the communications signal symbols s_{C}.

In some examples, the Rx node applies at least the prior knowledge of the sensing RS symbols and of the precoding transform W to perform a one-stage interference cancellation of the sensing RS signal component over the communications signal component based on the precoded joint communications and sensing signal (e.g., via the sensing processing components 220). The prior knowledge of sensing RS symbols and of the precoding transform may be acquired from an access network, or a peer transmitter node, such as via control signaling. For example, upon sensing RS interference cancellation, the s_{C} detection is:

$${( diag ( H ) )}^{- 1} \cdot y - {W}_{S} \cdot {s}_{s} = {W}_{C} {s}_{C} + {( diag ( H ) )}^{- 1} \cdot {D}_{N} \cdot n$$

where W, s are partitioned (e.g., by selecting the corresponding columns mapping to the disjoint sets S and C mapping the sensing RS and communications symbols to the inputs of the precoder W) into their corresponding sensing RS W_{S}, s_{S} and communications W_{C}, s_{C} precoded-signal subcomponents of the joint communications and sensing signal. A left-hand side signal vector (diag(H))⁻¹·y−W_{S}·sₛ∈ [symbol] ^{N×1} is the interference-free received communications signal subcomponent of the joint communications and sensing signal.

In some cases, the control signaling may include control information elements (IEs), such as downlink control information (DCI), uplink control information (UCI), or other control envelopes (e.g., RRC control messages), The IEs may include signaling corresponding to at least determining the sensing RS signal components and/or the precoding linear transform W used to generate the joint communications and sensing signal.

In some cases, the Rx node may apply W-based matched filtering (e.g., via W_{C}^{H}), least squares filtering, linear minimum mean square filtering, other linear-based detection filtering, non-linear detection filtering, and/or various combinations, to obtain s_{C}. For example, the Rx node may apply first matched filtering via the communications component subprecoder

$${W}_{C}^{H}$$

followed by parallelized Gaussian elimination, utilizing the spectral structure of the Grammian operator

$${W}_{C}^{H} {W}_{C} ,$$

which is symmetric with diagonal entries 1 via the W construction constrained to unit-norm column vectors.

As another example, the Rx node may directly apply Gaussian elimination and/or least squares on the invertible W_{C}. As another example, the Rx node may apply linear minimum mean square filtering, considering the noise variance and distribution post-demodulation, equalization, and sensing-signal interference cancellation. Further, the Rx node may apply non-linear data-driven learned receivers, such as those combined with other techniques.

In some examples, the transmitter and receiver processing may be collocated. For example, the processing collocation may be bounded within the same apparatus, comprising both the transmitter and receiver, performing the precoding and processing of the joint communications and sensing signal.

In some examples, the processing collocation may be bounded to a logical processing that is executed under a common processor or central processing unit. The central processing unit may be common to the transmitter node, may be common to the receiver node, or may be part of a network common to both the transmitter and receiver nodes. In examples where transmitter and receiver processing may be collocated, both monostatic and bi-static sensing tasks may be executed based on the non-orthogonally precoded joint communications and sensing signaling.

In some examples, the transmitter and receiver processing may be non-collocated. In some cases, the transmitter and receiver may include different peer apparatuses communicating with each other and exchanging information data based on the communications component of the joint communications and sensing signal. In other cases, the transmitter and receiver include different peer apparatuses communicating with each other and exchanging sensing RS signaling based on at least the sensing RS signal component of the joint communications and sensing signal.

In one example, the transmitter and receiver may be TRPs of an access network and/or peer entities in a local network. In another example, the transmitter may be an access network transmission-reception node and the receiver may be a UE, or alternatively, the transmitter may be a UE and the receiver may be a transmission-reception node of an access network. In examples where the transmitter and receiver processing may be non-collocated, only bi-static sensing tasks may be executed based on the non-orthogonally precoded joint communications and sensing signaling.

In some examples, an FEC decoder 362 receives the signal subcomponent, decodes the signal subcomponent, and transfers the decoded signal subcomponent to a communications sink 364 to release the detected communications message for higher layers processing.

As described herein, the receiving device 215, in some examples may perform channel estimation in the time domain. In some examples, the receiving device 215 may utilize a time-domain multiplexed reference signal for communications intrinsic sensing tasks, such as phase estimation and phase noise tracking and/or channel estimation, when equalizing a channel and/or detecting current and upcoming symbols. The receiving device 215 may perform the communication/sensing tasks directly in the time domain based on the time-domain multiplexed reference signal.

In some cases, the time-domain multiplexed reference signal is a DM-RS or a similar signal type that facilitates the receiving device 215 to obtain and/or measure a latest channel state information estimate and/or channel estimate corresponding to symbols receiving within a current transmission-reception time window.

In some examples, the receiving device 215 may be configured by the network (e.g., a base station, or alternatively, a RAN, with information regarding the DM-RS format, frequency, and/or time-domain allocation, within the time-domain multiplexing). For example, the receiving device 215 receives a configuration (e.g., the configuration 225) and applies the configuration to extract a time-domain signal of relevance corresponding to the DM-RS time-domain multiplexed signal component (e.g., using baseband time-domain processing via subsampling of a larger bandwidth or direct signal sampling across an entire reception bandwidth). The extracted time domain signal (e.g., the received time-domain DM-RS), may be a representation of a DM-RS time-domain signal transformed by linear convolution with a wireless channel excitation and effected by phase noise, carrier frequency offsets, and/or interference and receiver noise components.

After extracting the time domain signal, the receiving device 215 may input the time domain signal into an estimation block (e.g., deconvolution, matched filtering, and so on) to perform phase tracking, frequency and timing offset estimation, and/or channel estimation. The estimation block may include the DM-RS configuration (e.g., comprising a DM-RS sequence or function deriving the DM-RS sequence, a DM-RS allocation/multiplexing in the time domain, a DM-RS signaling frequency, or other components).

In some cases, the receiving device 215 may utilize the extracted time domain DM-RS for phase tracking and phase noise estimation. In doing so, the receiving device 215 may perform baseband processing with an enhanced equalization and detection and/or a minimized use of increased periodicity PT-RS signaling. The receiving device 215 may be configured with a reduced PT-RS configuration, indicating, explicitly (e.g., via a dedicated configuration element), or implicitly, that the receiving device 215 is to apply the DM-RS for phase noise tracking and correction, realizing a reduction of PT-RS signaling, signaling overhead, and/or efficient use of allocated spectrum, among other benefits.

In some cases, the receiving device 215 may utilize the extracted time-domain DM-RS for time-domain channel estimation. The receiving device 215 may perform the channel estimation via an estimator (e.g., least squares/zero-forcing, linear minimum mean square error, neural network-based inverse filtering, or other linear or non-linear functionality) that determines a channel estimate corresponding to a current transmission-reception occasion. For example, in the time domain, obtaining a channel estimate may involve a deconvolution and/or an inverse linear operation applied to the extracted time domain DM-RS with reference to the DM-RS used by the transmitting device 205 in the time domain.

In some examples, such as when a DM-RS is configured per UE (e.g., W is a per DFT-S-OFDM), each UE 104 may utilize an extracted time domain DM-RS to retrieve a channel estimate for an entire bandwidth allocated for UE information symbols.

In some examples, such as when a DM-RS is configured per subband (e.g., W is a per subband DFT-S-OFDM), each UE 104 may utilize an extracted time domain DM-RS to retrieve a channel estimate for an entire subband to which the UE 104 is tuned to listen to and multiplexed in with other UEs.

In examples, the DM-RS allocation/length, DM-RS sequence, and/or signal structure in time domain multiplexing may be configured by a RAN to optimize time domain CSI estimation processing. For example, the DM-RS allocation length may be configured such that its duration is larger than an expected channel spread. As another example, the DM-RS may be a signal pulse (e.g., a binary phase shift keying (BPSK)/quadrature phase shift keying (QPSK) series of modulated symbols prefixed and suffixed by one or more null or muted symbols). As another example, the DM-RS sequence may be derived as a sequence with a flat power spectrum and impulse-like autocorrelation function, such as a constant amplitude zero autocorrelation waveform (CAZAC) sequence (e.g., Zadoff-Chu, m-sequence, Gold sequence, and so on).

In some examples, the time domain allocation of multiplexed symbols may have various configurations. FIG. 5B illustrates time domain allocations 510 of symbols in accordance with aspects of the present disclosure. The time domain allocations 510 may include DM-RS symbols (or other reference symbols) and information symbols (or other remainder symbols). As shown, the DM-RS time-domain multiplexing may include a time-domain front-loaded DM-RS allocation 512 a time-domain interleaved DM-RS allocation 514, and/or a back-loaded DM-RS allocation 516.

In some examples, the assignment and allocation of the DM-RS in a time domain may be classified and/or indexed in some configurations as Type-X, forming a codebook of DM-RS allocations, and complementing existing DM-RS allocations in a frequency domain. For example, a Type-0 DM-RS may be associated with DM-RS allocations in a frequency domain (as per legacy 5G NR), a Type-1 DM-RS may be associated with a time-domain front-loaded DM-RS (allocation 512), a Type-2 DM-RS may be associated with a time-domain back-loaded DM-RS (allocation 516), and a Type-3 DM-RS may be associated with a time-domain interleaved DM-RS (allocation 514). In some cases, the DM-RS configuration/allocation and the DM-RS Type may be configured common for all devices (e.g., per subband) and/or per UE, user, or user device.

As described herein, the systems and methods may resolve issues associated with estimating medium parameters and detecting/estimating differential medium/medium parameters contribution to sensing tasks, along with detecting the communication signal components s_{C}. Example medium parameters include channel impulse response, channel frequency response, channel components magnitude, channel components phase, delay spread profile, Doppler spread profile, delay spread coefficients, Doppler spread coefficients, Doppler shift.

In some cases, a sensing task based on processing and tracking over time multiple medium/medium parameters realizations, or alternatively samples, may be object/obstacle detection, object/obstacle shape estimation, obstacle avoidance, direction of mobility of one or more obstacles, and so on.

In some examples, the Rx node, via an interference cancellation component 360, stores the received signal after the demodulation function (e.g., the OFDM demodulator, such as the FFT 342) as a demodulated baseband received signal of the joint communications and sensing signal. The Rx node may subtract the communications signal component from the demodulated baseband received signal of the joint communications and sensing signal. The noisy remainder signal comprises the known sensing RS excitation of the physical channel as follows:

$$y - diag ( \hat{H} ) \cdot {W}_{C} \cdot \hat{{s}_{c}} = diag ( H ) \cdot {W}_{S} \cdot {s}_{S} + {D}_{N} \cdot n$$

where the subtraction term diag(Ĥ)⁻¹·W_{C}· [symbol] comprises the latest estimate of the physical channel and the current detected communications signal components [symbol] . As such, yₛ=y−diag(Ĥ)⁻¹·W_{C}· [symbol] may be the sensing RS excitation of physical channel diag(H) in a frequency domain plus noise. The sensing RS excitation of the physical channel may therefore have an instantaneous Sensing Signal Noise Ratio (SSNR) of

$$SSNR = \frac{{‖ diag ( H ) \cdot {W}_{S} \cdot {s}_{S} ‖}_{2}^{2}}{{‖ n ‖}_{2}^{2}}$$

In some cases, the SSNR is based on a choice of sensing RS symbol coefficients set S and W construction, as described herein, where the detection and estimation of the channel new estimate, or diag(Ĥ_{new}), is to be solved when performing a sensing task. The dual of the SSNR is the Communications Signal to Noise Ratio:

$$CSNR = \frac{{‖ diag ( H ) \cdot {W}_{C} \cdot {s}_{C} ‖}_{2}^{2}}{{‖ n ‖}_{2}^{2}}$$

The CSNR may be obtained by removing the sensing RS interference cancellation from the demodulated baseband received signal of the joint communications and sensing signal. The relationship between the SSNR and CSNR relative to a compound SNR of the joint communications and sensing signal,

$$SNR = \frac{{‖ diag ( H ) \cdot W \cdot s ‖}_{2}^{2}}{{‖ n ‖}_{2}^{2}} ,$$

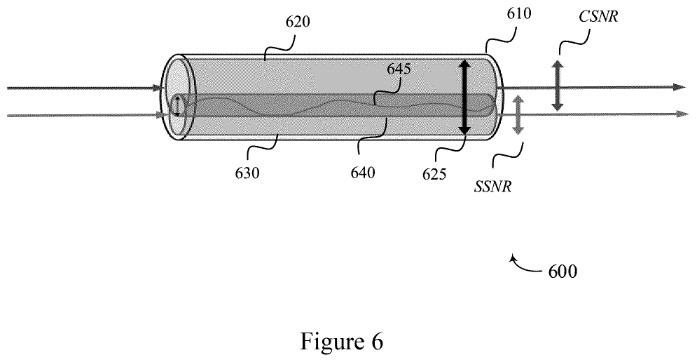

is depicted in FIG. 6.

FIG. 6 illustrates an example channel 600 for a joint communications and sensing signal in accordance with aspects of the present disclosure. Physical channel resources 610 includes a communications channel 620 and a sensing channel 630, which contain a precoder-based joint signal 625. A non-orthogonal multiplexed interference channel 640 arises, and includes instantaneous (e.g., symbol-level) interference 645.

In some cases, the instantaneous interference 645 between the communications channel 620, or representation, and the sensing channel 630, or representation in the joint communications and sensing space non-orthogonally multiplexed may be constructive or destructive, depending on the precoding linear transform W, the communications and sensing symbols s, and the physical channel instance diag(H). Thus, the type of interference may not be perfectly controllable. However, from the Rx node, the interference may be resolved and cancelled for both communications and sensing detection, as described herein.

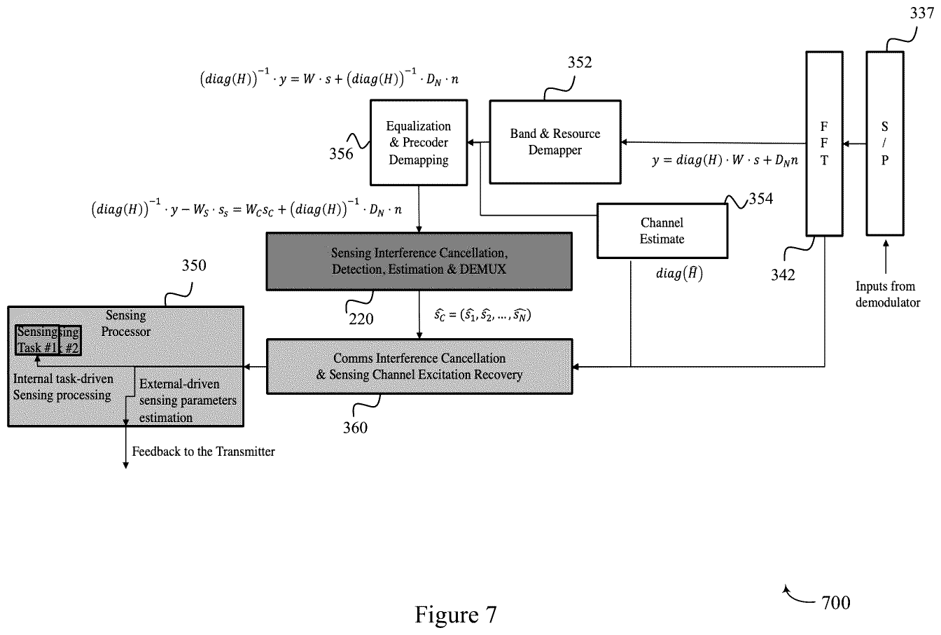

In some examples, the Rx node may determine a new estimate of sensing parameters based at least on the sensing task objectives, the demodulated baseband received signal of the joint communications and sensing signal, the knowledge of sensing RS signal components, the latest physical channel knowledge and the current sensing RS excitation of physical channel, or various combinations. FIG. 7 illustrates example targeting of sensing parameters to sensing tasks 700 in accordance with aspects of the present disclosure (with reference to the components/steps depicted in FIG. 3).

As described herein, the obtained sensing parameter estimates may be provided to the sensing processor 350, which may be within the receiver apparatus. In some cases, the sensing parameter estimates may be transmitted to the Tx node or another network node, or otherwise mapped to the sensing tasks.

Thus, in various examples, the systems and methods may enhance a transmitter (e.g., the UE 104) to non-orthogonally multiplex, compress, and spread independent communications and sensing signals into a joint communications and sensing signal mapped to available physical resources, which are less than the signaled independent communications and sensing signals components. In some cases, the transmitter includes a linear precoder (e.g., precoder 210 or 400) and a receiver includes an interference cancellation and detection component (e.g., component 220).

Using the various implementations, a wireless communications system may perform receiver-side disambiguation and processing of joint communications and sensing signals to individually benefit estimation and detection for dual information channels (e.g., communication channels and sensing channels), which simultaneously leveraging the available physical channel resources, among other benefits.

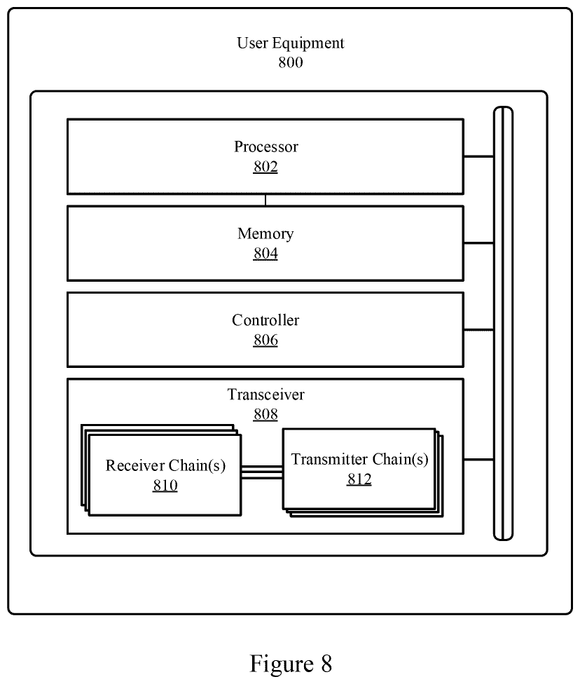

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions when executed by the processor 802 cause the UE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the UE 800 to perform one or more of the functions described herein (e.g., executing, by the processor 802, instructions stored in the memory 804). For example, the processor 802 may support wireless communication at the UE 800 in accordance with examples as disclosed herein. The UE 800 may be configured to support a means for receiving, over a frequency subband, a time-domain multiplexed signal, comprising: a first set of symbols associated with a reference source and a second set of symbols associated with an information source, performing a sensing task based on the time-domain multiplexed signal, and detecting the second set of symbols.

The controller 806 may manage input and output signals for the UE 800. The controller 806 may also manage peripherals not integrated into the UE 800. In some implementations, the controller 806 may utilize an operating system such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

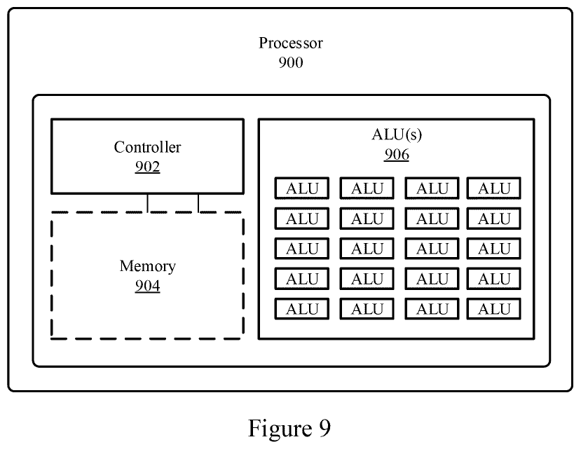

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory address of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, arithmetic logic units (ALUs), and other functional units of the processor 900.

The memory 904 may include one or more caches (e.g., memory local to or included in the processor 900 or other memory, such RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, the controller 902, and the memory 904 may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

The processor 900 may support wireless communication in accordance with examples as disclosed herein. The processor 900 may be configured to support a means for receiving, over a frequency subband, a time-domain multiplexed signal, comprising: a first set of symbols associated with a reference source and a second set of symbols associated with an information source, performing a sensing task based on the time-domain multiplexed signal, and detecting the second set of symbols.

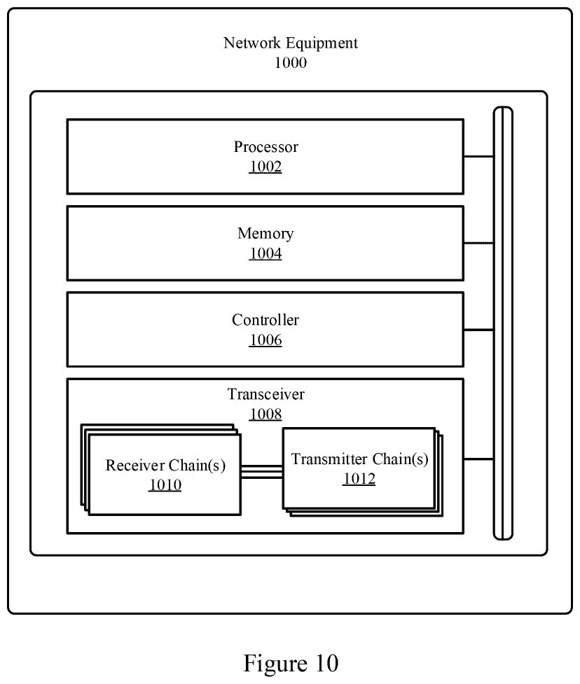

FIG. 10 illustrates an example of a NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more of the functions described herein (e.g., executing, by the processor 1002, instructions stored in the memory 1004). For example, the processor 1002 may support wireless communication at the NE 1000 in accordance with examples as disclosed herein. The NE 1000 may be configured to support a means for applying a time-domain precoder to multiplex a signal, comprising: a first set of symbols associated with a reference source and a second set of symbols associated with an information source, mapping the signal to a frequency subband, modulating the frequency subband to modulate the signal, and transmitting the modulated signal.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receive the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the processing the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

As described herein, various implementations may include the UE 800 as a Tx node or Rx node, the processor 900 as the Tx node or Rx node, and/or the NE 1000 as the Tx node or Rx node.

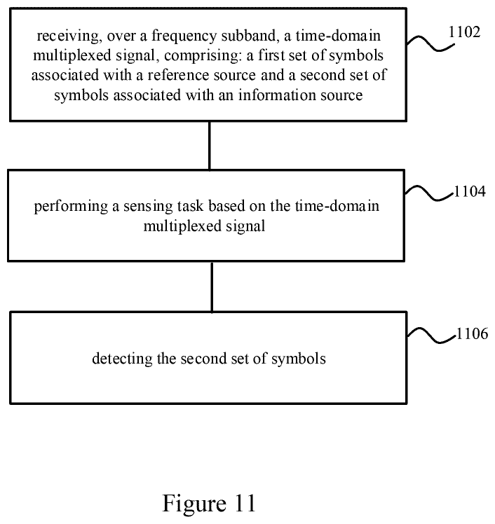

FIG. 11 illustrates a flowchart of a method in accordance with aspects of the present disclosure. The operations of the method may be implemented by a UE (e.g., as a receiving device or node) as described herein. In some implementations, the UE may execute a set of instructions to control the function elements of the UE to perform the described functions.

At 1102, the method may include receiving, over a frequency subband, a time-domain multiplexed signal, comprising: a first set of symbols associated with a reference source and a second set of symbols associated with an information source. The operations of 1102 may be performed in accordance with examples as described herein. In some implementations, aspects of the operations of 1102 may be performed by a UE as described with reference to FIG. 8.

At 1104, the method may include performing a sensing task based on the time-domain multiplexed signal. The operations of 1104 may be performed in accordance with examples as described herein. In some implementations, aspects of the operations of 1104 may be performed by a UE as described with reference to FIG. 8.

At 1106, the method may include detecting the second set of symbols. The operations of 1106 may be performed in accordance with examples as described herein. In some implementations, aspects of the operations of 1106 may be performed by a UE as described with reference to FIG. 8.

It should be noted that the method described herein describes a possible implementation, and that the operations and the steps may be rearranged or otherwise modified and that other implementations are possible.

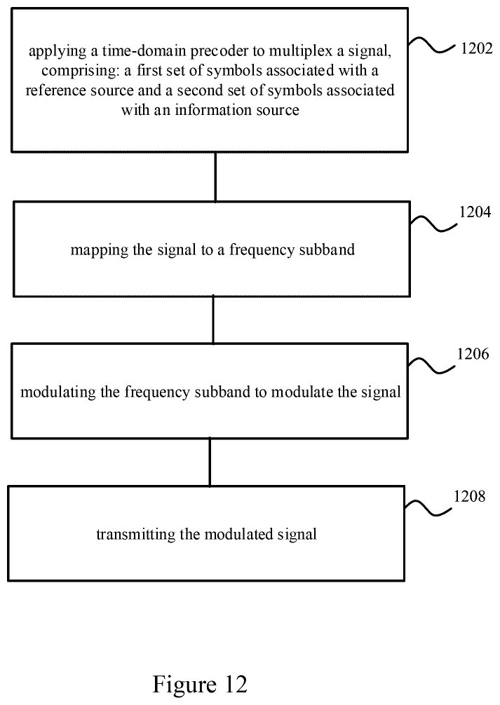

FIG. 12 illustrates a flowchart of a method in accordance with aspects of the present disclosure. The operations of the method may be implemented by an NE (as a transmitting device or node) as described herein. In some implementations, the NE may execute a set of instructions to control the function elements of the NE to perform the described functions.

At 1202, the method may include applying a time-domain precoder to multiplex a signal, comprising: a first set of symbols associated with a reference source and a second set of symbols associated with an information source. The operations of 1202 may be performed in accordance with examples as described herein. In some implementations, aspects of the operations of 1202 may be performed by an NE as described with reference to FIG. 10.

At 1204, the method may include mapping the signal to a frequency subband. The operations of 1204 may be performed in accordance with examples as described herein. In some implementations, aspects of the operations of 1204 may be performed by an NE as described with reference to FIG. 10.

At 1206, the method may include modulating the frequency subband to modulate the signal. The operations of 1206 may be performed in accordance with examples as described herein. In some implementations, aspects of the operations of 1206 may be performed by an NE as described with reference to FIG. 10.

At 1208, the method may include transmitting the modulated signal. The operations of 1208 may be performed in accordance with examples as described herein. In some implementations, aspects of the operations of 1208 may be performed by an NE as described with reference to FIG. 10.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
one or more memories; and
one or more processors coupled with the one or more memories and individually or collectively configured to cause the network entity to:
apply a time-domain precoder to multiplex a signal, comprising:
a first set of symbols associated with a reference source; and
a second set of symbols associated with an information source;
map the signal to a frequency subband;
modulate the frequency subband to modulate the signal; and
transmit the modulated signal.

2. The network entity of claim 1, wherein the one or more processors are further individually or collectively configured to cause the network entity to multiplex the signal with a third set of symbols associated with another information source.

3. The network entity of claim 1, wherein the first set of symbols represents a demodulation reference signal (DM-RS) associated with a sensing task.

4. The network entity of claim 3, wherein the sensing task includes phase tracking, phase noise estimation, or channel estimation.

5. The network entity of claim 3, wherein the DM-RS is time-domain multiplexed within the signal with respect to one or more sets of symbols.

6. The network entity of claim 5, wherein the DM-RS is front-loaded with respect to the one or more sets of symbols, back-loaded with respect to the one or more sets of symbols, or interleaved with the one or more sets of symbols.

7. The network entity of claim 3, wherein the DM-RS comprises a constant-amplitude zero-autocorrelation (CAZAC) sequence or a time-domain impulse function.

8. The network entity of claim 1 wherein the time-domain precoder comprises a Discrete Fourier Transform (DFT).

9. The network entity of claim 1, wherein the one or more processors are further individually or collectively configured to cause the network entity to modulate the signal via Orthogonal Frequency Division Multiplexing (OFDM).

10. A user equipment (UE) for wireless communication, comprising:
one or more memories; and
one or more processors coupled with the one or more memories and individually or collectively configured to cause the UE to:
receive, over a frequency subband, a time-domain multiplexed signal, comprising:
a first set of symbols associated with a reference source; and
a second set of symbols associated with an information source;
perform a sensing task based on the time-domain multiplexed signal; and
detect the second set of symbols.

11. The UE of claim 10, wherein the first set of symbols represents a demodulation reference signal (DM-RS) associated with the sensing task.

12. The UE of claim 11, wherein the sensing task includes phase tracking, phase noise estimation, or channel estimation.

13. The UE of claim 10, wherein the one or more processors are further individually or collectively configured to cause the UE to:
receive a configuration that indicates a format and a time-domain allocation of one or more reference signals associated with the reference source or a time-domain allocation of the second set of symbols;
apply the configuration to extract a demodulation reference signal (DM-RS) from the time-domain multiplexed signal;
input the DM-RS into an estimation block to perform the sensing task; and
detect the second set of symbols based at least on an output of the sensing task.

14. The UE of claim 13, wherein the one or more processors are further individually or collectively configured to cause the UE to:
receive, over the frequency subband, the time-domain multiplexed signal, wherein time-domain multiplexed signal comprises a third set of symbols associated with another information source; and
discard the third set of symbols associated with the other information source.

15. The UE of claim 13, wherein the DM-RS is specifically configured for the UE and wherein the sensing task includes determining a channel estimate for a bandwidth allocated for the second set of symbols associated with the information source.

16. The UE of claim 13, wherein the DM-RS is configured for a subband and wherein the sensing task includes determining a channel estimate for the subband.

17. The UE of claim 13, wherein the DM-RS is time-domain multiplexed within the time-domain multiplexed signal with respect to one or more sets of symbols.

18. The UE of claim 17, wherein the DM-RS is front-loaded with respect to the one or more sets of symbols, back-loaded with respect to the one or more sets of symbols, or interleaved with the one or more sets of symbols.

19. A method performed by a network entity, the method comprising:
applying a time-domain precoder to multiplex a signal, comprising:
a first set of symbols associated with a reference source; and
a second set of symbols associated with an information source;
mapping the signal to a frequency subband;
modulating the frequency subband to modulate the signal; and
transmitting the modulated signal.

20. A method performed by a user equipment (UE), the method comprising:
receiving, over a frequency subband, a time-domain multiplexed signal, comprising:
a first set of symbols associated with a reference source; and
a second set of symbols associated with an information source;
performing a sensing task based on the time-domain multiplexed signal; and
detecting the second set of symbols.
